(19) United States
(12) Patent Application Publication
(10) Pub. No.: US 2025/0363021 A1
(43) Pub. Date: Nov. 27, 2025

(54) STORAGE MANAGEMENT SYSTEM AND STORAGE MANAGEMENT METHOD

(71) Applicant: Hitachi Vantara, Ltd., Yokohama-shi (JP)

(72) Inventors: Jingtao SUN, Tokyo (JP); Satoshi KANEKO, Tokyo (JP)

(73) Assignee: Hitachi Vantara, Ltd., Yokohama-shi (JP)

(21) Appl. No.: 19/064,964

(22) Filed: Feb. 27, 2025

(30) Foreign Application Priority Data
May 21, 2024 (JP) 2024-082527

(51) Int. Cl. G06F 11/20; G06F 11/00

(52) U.S. Cl. CPC G06F 11/2089; G06F 11/006; G06F 2201/805

(57) ABSTRACT

In a hybrid cloud environment, a faulty job is identified and fault recovery is conducted under integrated control of storage set up at multiple sites. A system manages storage set up at multiple sites, using a low-level API for each set of storage, and has a high-level API integrally controlling the low-level APIs. The system includes an API interdependence data generation unit generating interdependence data describing API interdependence-related information upon calling of a low-level API, depending on low-level API use status, a job interdependence data generation unit that generates interdependence meta data upon successful job execution by the high-level API, and a fault identification unit that identifies a fault of the low-level API upon failure of the high-level API to execute a job, by using an interdependence data structure generated by the API interdependence data generation unit and the interdependence meta data generated by the job interdependence data generation unit.

### BACKGROUND OF THE INVENTION

### 1. Field of the Invention

The present invention relates to a storage management system and a storage management method.

### 2. Description of the Related Art

In recent years, there has been practiced centralized management of more than one set of storage set up at multiple sites, in a hybrid cloud environment. In such a case, the method of managing each set of storage involves providing low-level application programming interfaces (APIs) individually managing more than one set of storage at multiple sites under a separately provided high-level API that integrally controls the more than one set of storage at the sites. The method enables a storage user to make use of the more than one set of storage at all sites under the high-level API. This facilitates management of the more than one set of storage set up at the multiple sites.

JP-2015-170344-A describes techniques for suitably managing stacks of virtual resource groups. According to the techniques disclosed in JP-2015-170344-A, a failure to manage the virtual resource groups is followed by analysis of the failure through a rollback.

### SUMMARY OF THE INVENTION

In the case where the more than one set of storage set up at multiple sites are managed by use of multiple APIs including low-level APIs and a high-level API and where a storage read error, for example, occurs during execution of a low-level API, it is difficult for the high-level API operated by the user to identify the cause of the fault and recover from that fault.

That is, on the side of the high-level API, the interdependence between the low-level APIs in execution and the interdependence between jobs are not clear. This makes it difficult for the high-level API to identify a faulty job and conduct fault recovery accordingly.

For example, as described in JP-2015-170344-A, there exist techniques for analyzing errors by performing rollbacks. However, in a case where the low-level and high-level APIs are in use, it is difficult to know the interdependence between the APIs beforehand. This makes it difficult with the existing techniques to identify and recover from the fault occurring during execution of the high-level API.

It is therefore an object of the present invention to provide a storage management system and a storage management method for suitably identifying a faulty job and conducting fault recovery in a hybrid cloud environment where more than one set of storage set up at multiple sites are integrally managed.

In order to solve the foregoing problems, a configuration described in claims, for example, is adopted.

The present application includes multiple means for solving the foregoing problems, and as an example thereof, there is provided a storage management system for managing more than one set of storage set up at multiple sites, by using a low-level storage management interface provided for each set of storage, the storage management system further having a high-level storage management interface integrally controlling the low-level storage management interfaces.

The storage management system as an example of the present application includes a storage management interface interdependence data generation unit configured to generate interdependence data describing information regarding interdependence between the storage management interfaces upon calling of any low-level storage management interface depending on use status of the low-level storage management interfaces, a job interdependence data generation unit configured to generate interdependence meta data upon successful execution of a job by the high-level storage management interface, and a fault identification unit configured to identify a fault of the low-level storage management interface upon failure of the high-level storage management interface to execute a job, the identification being performed by use of an interdependence data structure generated by the storage management interface interdependence data generation unit and the interdependence meta data generated by the job interdependence data generation unit.

The present invention permits identifying the interdependence between multiple storage management interfaces in execution and the interdependence between jobs. This simplifies management operations at the time of error occurrence and facilitates recovery from the error.

Problems, configurations, and advantages other than those described above will become evident from a reading of the following detailed description of a preferred embodiment.

### BRIEF DESCRIPTION OF THE DRAWINGS

FIG. 1 is an overall configuration diagram of an exemplary system according to an embodiment of the present invention;

FIG. 2 is a configuration diagram of an exemplary storage management system according to the embodiment of the present invention;

FIG. 3 is a tabular view of an exemplary user request execution history table according to the embodiment of the present invention;

FIG. 4 is a configuration diagram of an exemplary master server control unit and an exemplary slave server group control unit according to the embodiment of the present invention;

FIG. 5 is a configuration diagram of an exemplary fault detection and recovery system according to the embodiment of the present invention;

FIG. 6 is a configuration diagram of an exemplary job interdependence data generation unit according to the embodiment of the present invention;

FIG. 7 is a configuration diagram of an exemplary site interdependence data asynchronization unit according to the embodiment of the present invention;

FIG. 8 is a configuration diagram of an exemplary API fault identification and recovery unit according to the embodiment of the present invention;

FIG. 9 is a configuration diagram of an exemplary user notification unit according to the embodiment of the present invention;

FIG. 10 is a flowchart of an exemplary overall flow of processing performed by a master server and a slave server group according to the embodiment of the present invention;

FIG. 11 is a flowchart of exemplary processing performed by an API interdependence data generation unit according to the embodiment of the present invention;

FIG. 12 is a flowchart of exemplary processing performed by the job interdependence data generation unit according to the embodiment of the present invention;

FIG. 13 is a flowchart of exemplary processing performed by the site interdependence data asynchronization unit according to the embodiment of the present invention;

FIG. 14 is a flowchart of exemplary processing performed by the API fault identification and recovery unit according to the embodiment of the present invention;

FIG. 15 is a flowchart of exemplary processing performed by the user notification unit according to the embodiment of the present invention;

FIG. 16 depicts an exemplary display screen of fault information according to the embodiment of the notification present invention;

FIG. 17 depicts an exemplary state of interdependence data asynchronization and fault recovery (example 1: cloud storage is not used) according to the embodiment of the present invention; and

FIG. 18 depicts an exemplary state of interdependence data asynchronization and fault recovery (example 2: cloud storage is used) according to the embodiment of the present invention.

### DESCRIPTION OF THE PREFERRED EMBODIMENT

A storage management system and a storage management method according to an embodiment of the present invention (referred to as the “present embodiment” hereunder) are described below with reference to the accompanying drawings.

### [Overall Configuration of System]

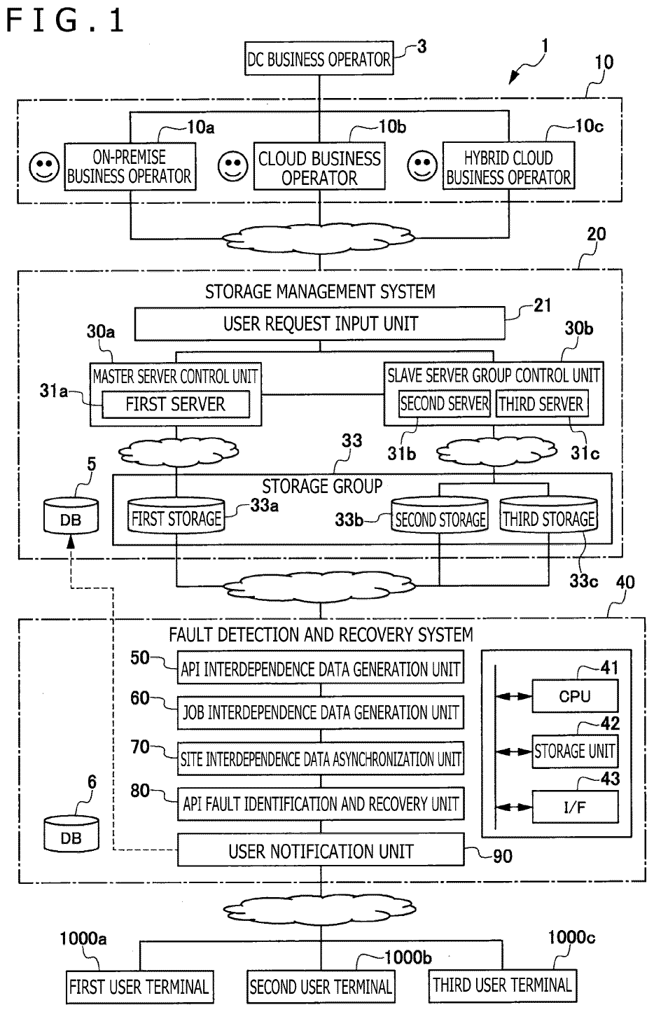

FIG. 1 depicts an exemplary overall configuration of a hybrid cloud system 1 of the present embodiment.

The hybrid cloud system 1 includes an on-premise business operator 10a, a cloud business operator 10b, and a hybrid cloud business operator 10c acting as business operators 10. Terminals at these business operators 10a, 10b, and 10c are configured to be accessible by a storage management system 20 via a cloud environment. In the description that follows, the business operators 10a, 10b, and 10c will be referred to as a first data center business operator, a second data center business operator, and a third data center business operator, respectively.

The storage management system 20 includes a user request input unit 21, a master server control unit 30a, a slave server group control unit 30b, a storage group 33, and a database 5.

The user request input unit 21 performs input processing on requests from user terminals 1000a, 1000b, and 1000c as well as on requests from the business operators 10a, 10b, and 10c.

The master server control unit 30a performs control of a first server 31a.

The slave server group control unit 30b performs control of a second server 31b, a third server 31c, etc., as slave servers.

The storage group 33 provides a first storage 33a, a second storage 33b, and a third storage 33c for storing data under control of their respective servers 31a, 31b, and 31c.

Whereas two servers and two sets of storage are indicated as the slaves in FIG. 1, there may be provided servers and storage in any number depending on the data storage capacity involved. In the case of the hybrid cloud system 1, the storage 33a, the storage 33b, and the storage 33c making up the storage group 33 are set up at multiple sites via a network.

The storage management system 20 of the present embodiment includes the database 5. The database 5 stores fault detection and recovery information reported from a fault detection and recovery system 40.

When the servers 31a, 31b, and 31c control the storage 33a, the storage 33b, and the storage 33c, respectively, they use storage management interfaces known as APIs. In the description that follows, the storage management interface will be referred to as the API.

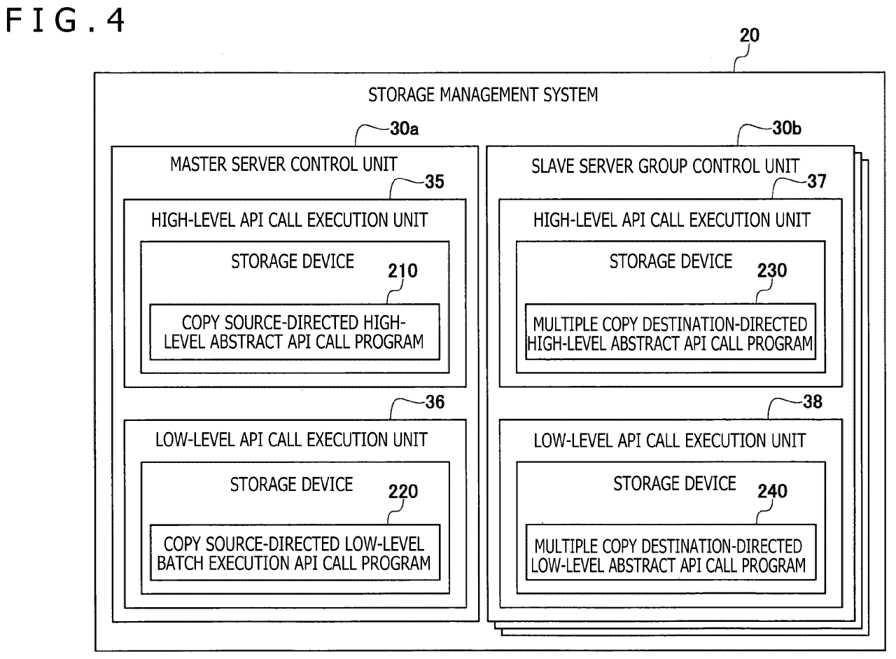

In the case of the present embodiment, the storage 33a, the storage 33b, and the storage 33c set up at multiple sites are controlled by the low-level APIs provided for the servers 31a, 31b, and 31c, respectively. Further, there is provided a high-level API that integrally controls the servers 31a, 31b, and 31c under the respective low-level APIs. The high-level API performs coordination processing on the more than one set of storage and servers at the sites. A configuration controlled by the APIs will be explained later with reference to FIG. 4.

The hybrid cloud system 1 of the present embodiment has the fault detection and recovery system 40.

The fault detection and recovery system 40 includes an API interdependence data generation unit 50, a job interdependence data generation unit 60, a site interdependence data asynchronization unit 70, an API fault identification and recovery unit 80, and a user notification unit 90. The fault detection and recovery system 40 also has a database 6. The database 6 stores fault detection and recovery information obtained by the fault detection and recovery system 40.

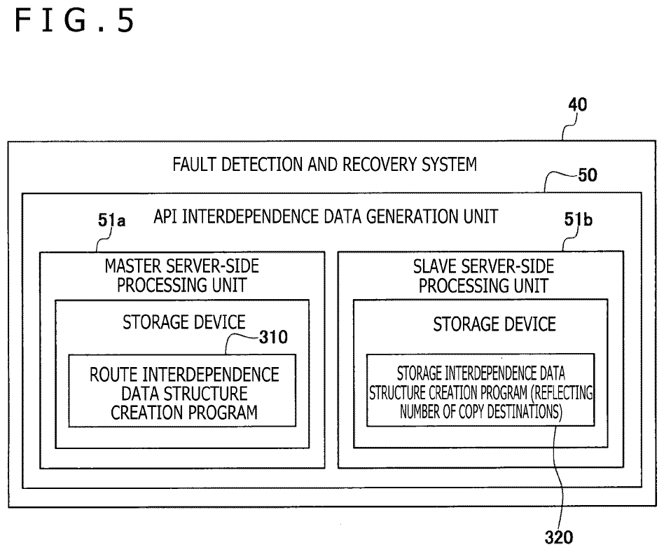

Configurations of the processing units 50 through 90 making up the fault detection and recovery system 40 will be explained later with reference to FIGS. 5 through 9.

In terms of hardware, the fault detection and recovery system 40 includes a central processing unit (CPU) 41, a storage unit 42, and an interface 43 interconnected with one another via a bus line for data transfer. Programs provided in the storage unit 42 are executed by the CPU 41 to configure the above-mentioned processing units 50 through 90 and the database 6 in the storage unit 42.

In the ensuing description of the configurations and processing, it is assumed that the data (copy source data) stored in the storage 33a as the first server (master server) is copied (as copy destination data) to the storage 33b or 33c as the second or third server (slave server).

### [Configuration of User Request Input Unit]

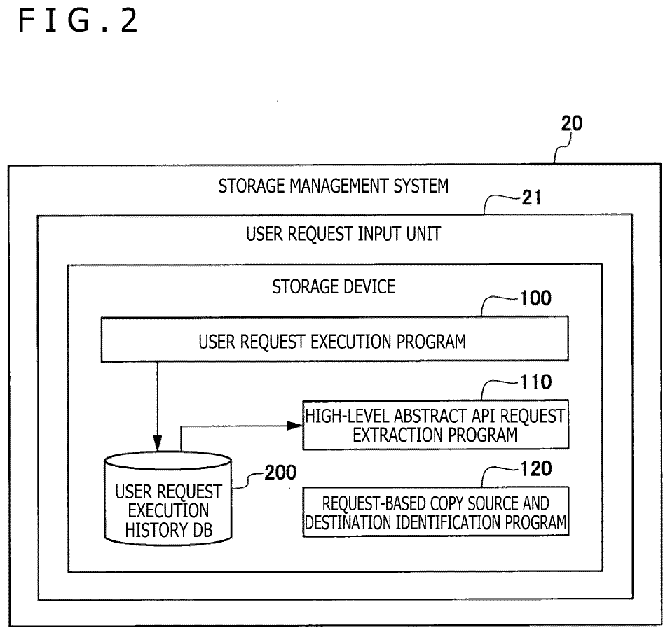

FIG. 2 depicts a configuration of the user request input unit 21 in the storage management system 20. Indicated in FIG. 2 is the user request input unit 21 configured in a storage device of a computer working as the user request input unit 21.

The user request input unit 21 includes a user request execution program 100, a high-level abstract API request extraction program 110, and a request-based copy source and destination identification program 120.

The user request execution program 100 lists user requests in a user request execution history table 200 for storage into the database.

The high-level abstract API request extraction program 110 extracts requests for the high-level API from the user requests stored in the user request execution history table 200.

The request-based source copy and destination identification program 120 identifies the source storage from which data is copied and the destination storage to which the data is copied, on the basis of the user request.

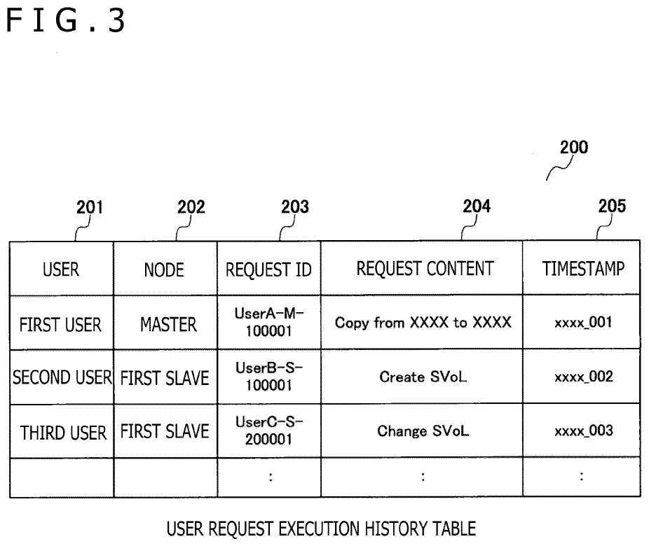

FIG. 3 depicts an exemplary data structure of the user request execution history table 200.

As indicated in FIG. 3, the user request execution history table 200 includes a user field 201, a node field 202, a request identification (ID) field 203, a request content field 204, and a timestamp field 205.

The user field 201 stores data identifying the user terminals 1000a, 1000b, and 1000c as a first user, a second user, and a third user, for example.

The node field 202 stores the names of nodes such as the master and the first slave that have executed requests.

The request ID field 203 stores IDs each given to each of the requests from the user terminals.

The request content field 204 stores specific content details that have been requested.

The timestamp field 205 stores timestamps indicative of the dates and times at which the requests were issued.

### [Configurations of Servers in Storage Management System]

FIG. 4 depicts configurations of the master server control unit 30a and the slave server group control unit 30b in the storage management system 20.

The master server control unit 30a includes a high-level API call execution unit 35 and a low-level API call execution unit 36.

A storage device of the high-level API call execution unit 35 holds a copy source-directed high-level abstract API call program 210. A storage device of the low-level API call execution unit 36 holds a copy source-directed low-level batch execution API call program 220.

The slave server group control unit 30b is provided for each of the storage 33b, the storage 33c, etc., as the slaves indicated in FIG. 1. Each slave server group control unit 30b includes a high-level API call execution unit 37 and a low-level API call execution unit 38.

A storage device of the high-level API call execution unit 37 holds a multiple copy destination-directed high-level abstract API call program 230. A storage device of the low-level API call execution unit 38 holds a multiple copy destination-directed low-level abstract execution API call program 240.

### [Fault Detection and Recovery System]

A configuration of the fault detection and recovery system 40 is explained next with reference to FIGS. 5 through 9.

FIG. 5 depicts the configuration of the API interdependence data generation unit (storage management interface interdependence data generation unit) 50 in the fault detection and recovery system 40.

The API interdependence data generation unit 50 includes a master server-side processing unit 51a and a slave server-side processing unit 51b.

A storage device of the master server-side processing unit 51a holds a route interdependence data structure creation program 310.

A storage device of the slave server-side processing unit 51b holds a storage interdependence data structure creation program 320. There are provided as many slave server-side processing units 51b as the number of the slaves involved.

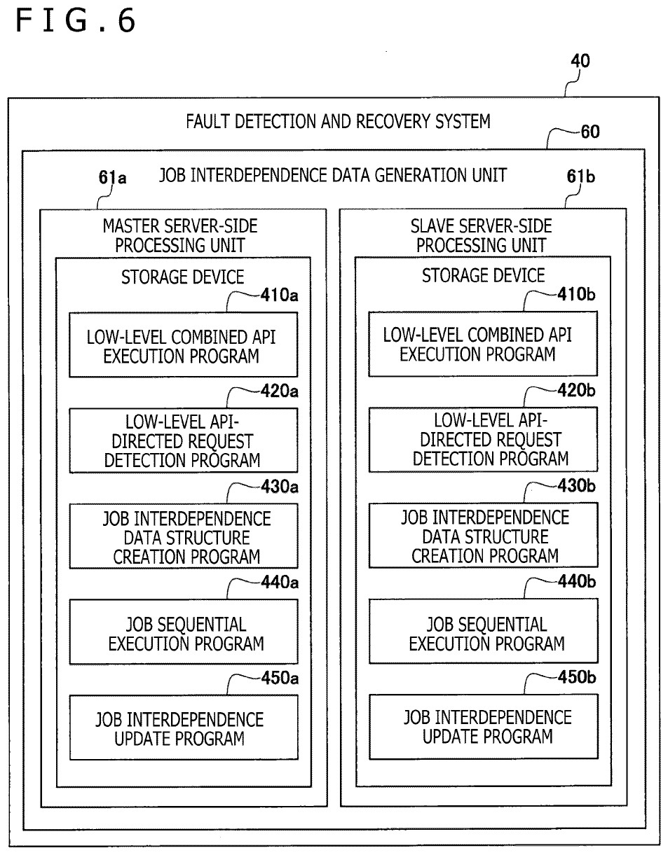

FIG. 6 depicts the configuration of the job interdependence data generation unit 60 in the fault detection and recovery system 40.

The job interdependence data generation unit 60 includes a master server-side processing unit 61a and a slave server-side processing unit 61b.

A storage device of the master server-side processing unit 61a holds a low-level combined API execution program 410a, a low-level API-directed request detection program 420a, and a job interdependence data structure creation program 430a. The storage device of the master server-side processing unit 61a further holds a job sequential execution program 440a and a job interdependence update program 450a.

A storage device of the slave server-side processing unit 61b holds a low-level combined API execution program 410b, a low-level API-directed request detection program 420b, and a job interdependence data structure creation program 430b. The storage device of the slave server-side processing unit 61b further holds a job sequential execution program 440b and a job interdependence update program 450b.

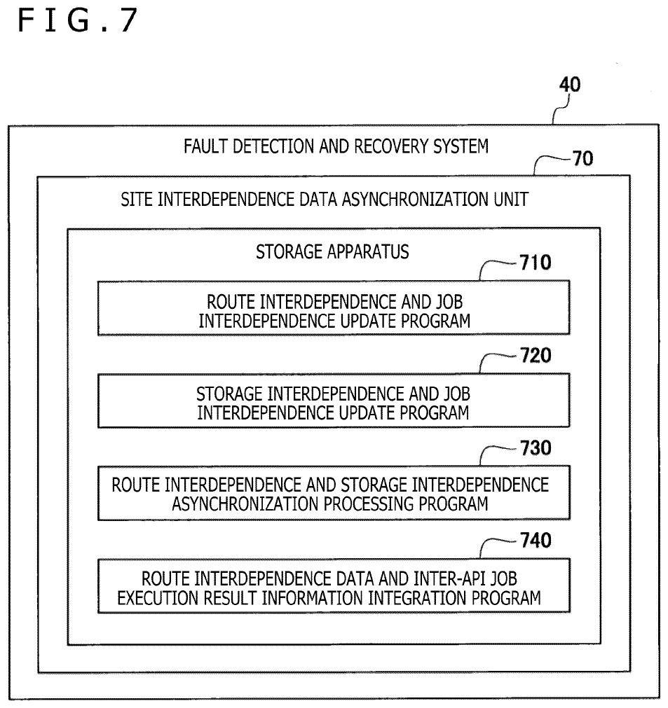

FIG. 7 depicts the configuration of the site interdependence data asynchronization unit 70 in the fault detection and recovery system 40.

A storage device of the site interdependence data asynchronization unit 70 holds a route interdependence and job interdependence update program 710; and a storage interdependence and job interdependence update program 720. The storage device of the site interdependence data asynchronization unit 70 further holds a route interdependence and storage interdependence asynchronization processing program 730; and a route interdependence data and inter-API job execution result information integration program 740.

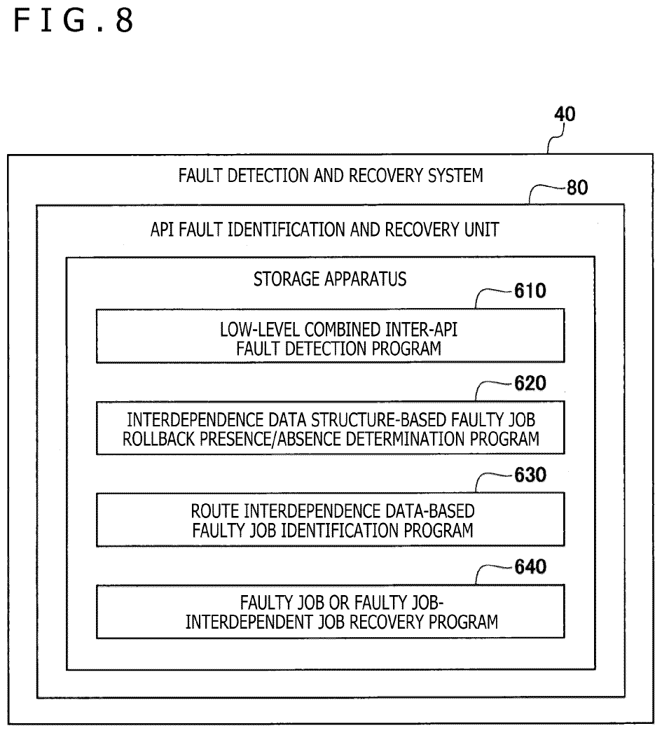

FIG. 8 depicts the configuration of the API fault identification and recovery unit 80 in the fault detection and recovery system 40.

A storage device of the API fault identification and recovery unit 80 holds a low-level combined inter-API fault detection program 610, an interdependence data structure-based faulty job rollback presence/absence determination program 620, and a route interdependence data-based faulty job identification program 630. The rollback in this context refers to detecting an automatic recovery checkpoint, which is a non-fault point, and passing processing control to the detected automatic recovery checkpoint for a retry in an automatic rollback.

In a case where the automatic rollback is determined to be present, the high-level API should preferably be notified periodically of information regarding the interdependence between low-level API jobs and the execution status of each task.

The storage device of the API fault identification and recovery unit 80 further holds a faulty job or faulty job-interdependent job recovery program 640.

In the present embodiment, the API fault identification and recovery unit 80 is configured to have both a fault detection function as a fault identification unit that identifies a fault and a fault recovery function that recovers from the identified fault. Alternatively, in a case where another system performs fault recovery, the API fault identification and recovery unit 80 may be provided with only the function as the fault identification unit.

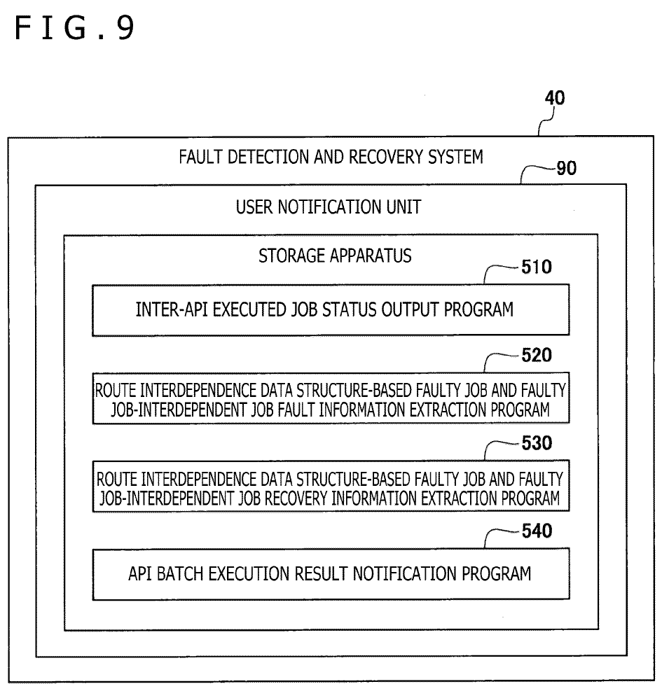

FIG. 9 depicts the configuration of the user notification unit 90 in the fault detection and recovery system 40.

A storage device of the user notification unit 90 holds an inter-API executed job status output program 510; and a route interdependence data structure-based faulty job and faulty job-interdependent job fault information extraction program 520.

The storage device of the user notification unit 90 further holds a route interdependence data structure-based faulty job and faulty job-interdependent job recovery information extraction program 530; and an API batch execution result notification program 540.

### [Overall Flow of Processing by Master Server and Slave Server Group]

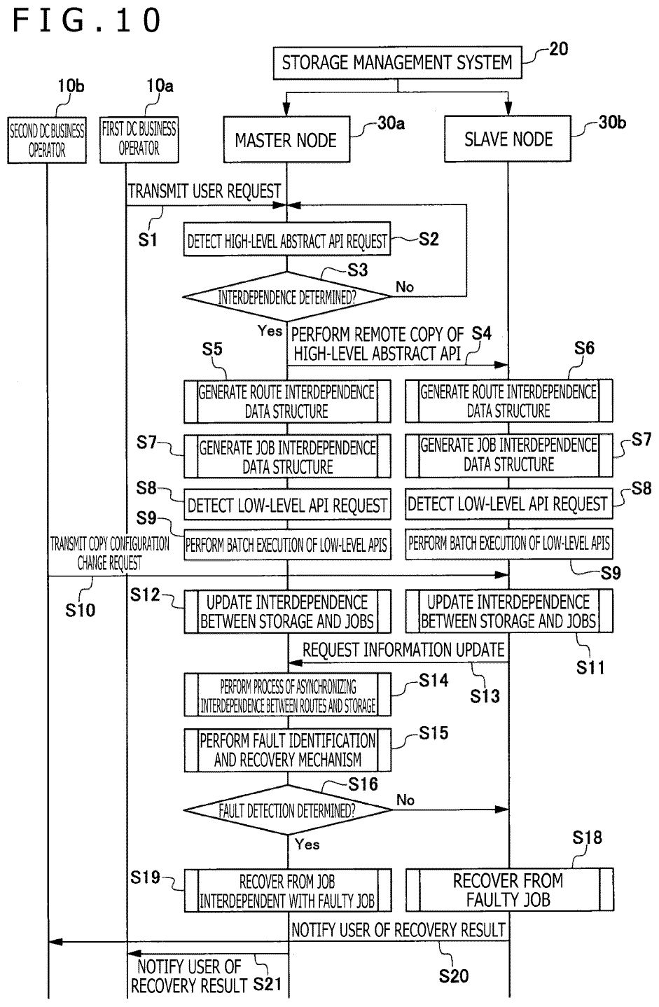

FIG. 10 is a flowchart indicating an overall flow of processing performed by the master server and the slave server group.

In the example of FIG. 10, the first data center business operator 10a transmits a user request in step S1, and the second data center business operator 10b transmits a copy configuration change request in step S10. That is, the example in FIG. 10 indicates how the master node (master server control unit) 30a and the slave node (slave server group control unit) 30b in the storage management system 20 perform their processing when these requests are transmitted.

First, the first data center business operator 10a transmits a user request to the master node 30a (step S1). Upon receipt of the user request, the master node 30a detects a high-level abstract API request (step S2). The master node 30a then determines whether interdependence has been determined (step S3). In a case where the determination of interdependence has yet to end in step S3 (No in step S3), processing control is returned to step S2.

In a case where the determination of interdependence has ended in step S3 (Yes in step S3), the master node 30 causes the slave node 30b to perform a remote copy of the high-level abstract API (step S4).

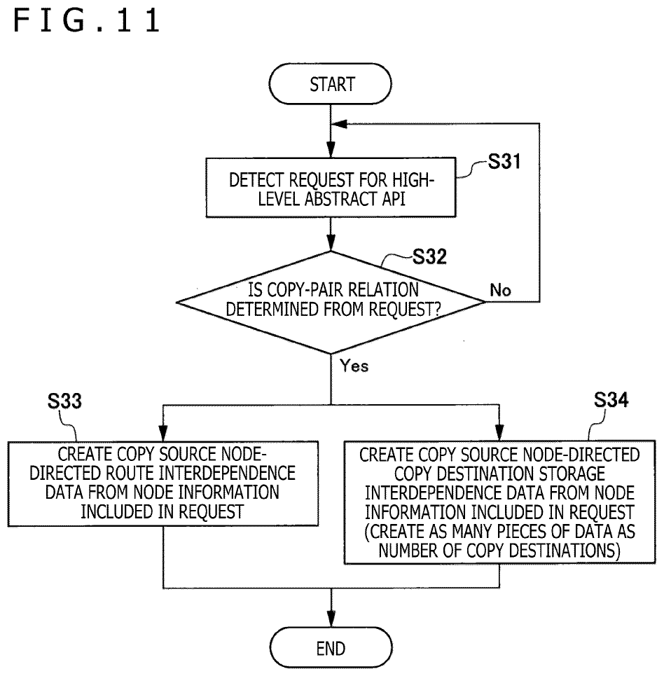

The master node 30a then performs a process of generating a route interdependence data structure (step S5). The slave node 30b also carries out the process of generating the route interdependence data structure (step S6). The processes of generating the route interdependence data structure in steps S5 and S6 will be discussed later in detail with reference to FIG. 11.

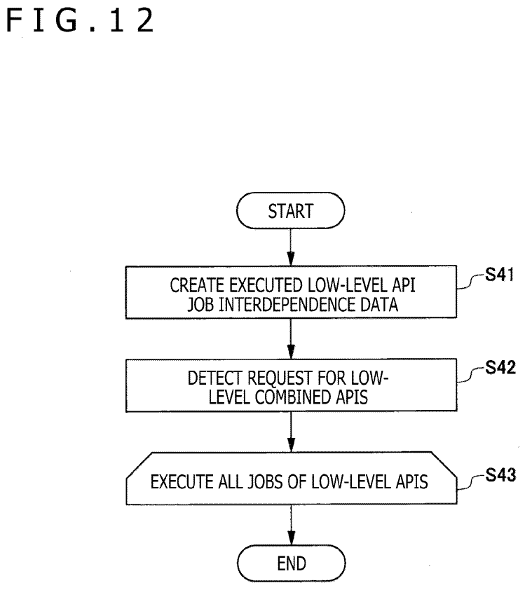

Next, the master node 30a performs a process of generating a job interdependence data structure (step S7). The slave node 30b also carries out the process of generating the job interdependence data structure (step S7). The processes of generating the job interdependence data structure in steps S7 and S8 will be discussed later in detail with reference to FIG. 12.

Next, the master node 30a and the slave node 30b perform batch execution of the low-level APIs (step S9).

Here, suppose that the second data center business operator 10b transmits a copy configuration change request (step S10). At this point, the slave node 30b updates the interdependence between the storage and the jobs (step S11). The master node 30a also updates the interdependence between the storage and the jobs (step S12).

Thereafter, the slave node 30b issues an information update request to the master node 30a (step S13). Upon receipt of the information update request, the master node 30a performs a process of asynchronizing the interdependence between the routes and the storage (step S14). The master node 30a further executes a fault identification and recovery mechanism (step S15), to see whether fault detection is determined (step S16).

In a case where no fault detection is determined in the determination of step S16 (No in step S16), the slave node 30b recovers from the faulty job (step S18). In a case where fault detection is determined in the determination of step S16 (Yes in step S16), the master node 30 recovers from the job interdependent with the faulty job (step S19).

The slave node 30b then notifies the user (second data center business operator 10b) of the result of the recovery (step S20). The master node 30 also notifies the user of the recovery result (step S21).

FIG. 11 is a flowchart of exemplary processing (storage management interface interdependence data generation process) performed by the API interdependence data generation unit 50 (see FIG. 5) in the fault detection and recovery system 40.

The API interdependence data generation unit 50 detects a request for the high-level abstract API (step S31). Upon detection of the request, the API interdependence data generation unit 50 determines whether a copy-pair relation is determined from the request (step S32). In a case where no copy-pair relation is determined in step S32 (No in step S32), the API interdependence data generation unit 50 returns to the request detection process of step S31.

In a case where a copy-pair relation is determined in step S32 (Yes in step S32), the master server-side processing unit 51a creates copy source node-directed route interdependence data from node information included in the request (step S33). Also, the slave server-side processing unit 51b creates copy source node-directed copy destination storage interdependence data from the node information included in the request (step S34). Multiple pieces of the copy destination storage interdependence data are created in step S34 depending on the number of copy destinations.

FIG. 12 is a flowchart of exemplary processing (job interdependence data generation process) performed by the job interdependence data generation unit 60 (see FIG. 6) in the fault detection and recovery system 40.

The job interdependence data generation unit 60 creates data of interdependence between executed low-level API jobs (step S41).

Next, the job interdependence data generation unit 60 detects a request for low-level combined APIs (step S42).

Thereafter, the storage management system 20 executes all jobs of the low-level APIs (step S43).

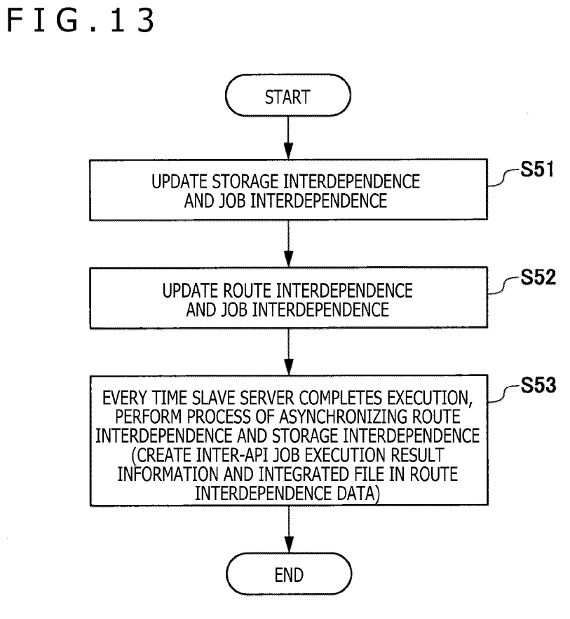

FIG. 13 is a flowchart of exemplary processing performed by the site interdependence data asynchronization unit 70 (see FIG. 7) in the fault detection and recovery system 40.

The site interdependence data asynchronization unit 70 updates the storage interdependence and job interdependence (step S51). Also, the site interdependence data asynchronization unit 70 updates the route interdependence and job interdependence (step S52).

Then, every time the slave server completes execution of a job, the site interdependence data asynchronization unit 70 performs a process of asynchronizing the route interdependence and storage interdependence (step S53). The asynchronization process creates inter-API job execution result information and an integrated file in the route interdependence data.

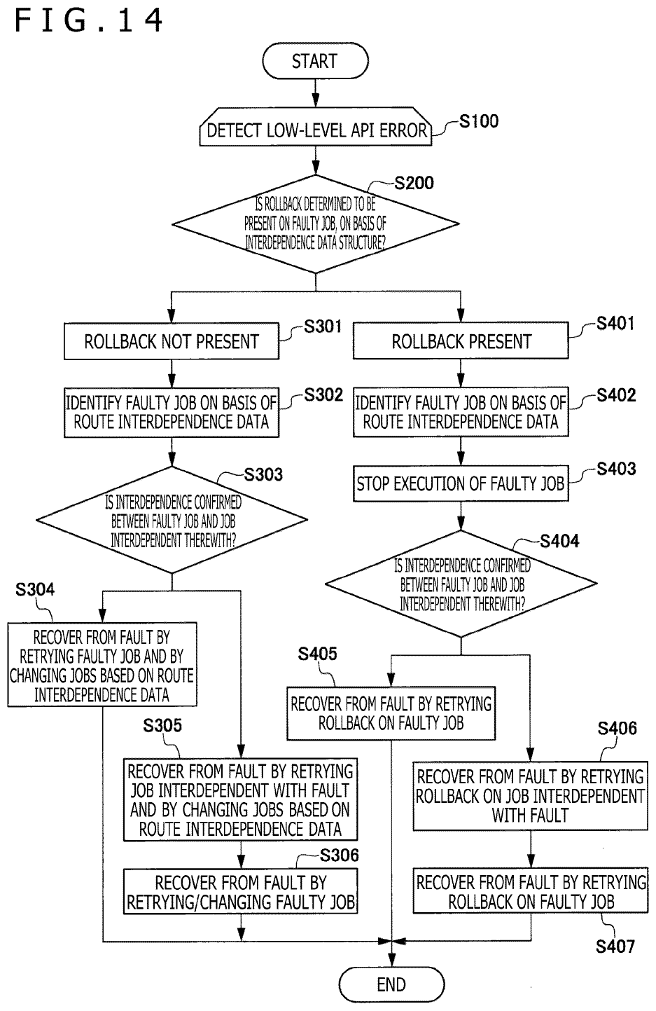

FIG. 14 is a flowchart of exemplary processing performed by the API fault identification and recovery unit 80 (see FIG. 8) in the fault detection and recovery system 40.

First, the API fault identification and recovery unit 80 starts processing by detecting a low-level API error (step S100).

With the processing started in step S100, the API fault identification and recovery unit 80 determines whether an automatic rollback is present on the faulty job, on the basis of the interdependence data structure (step S200).

If it is determined in step S200 that an automatic rollback is absent (step S301), the API fault identification and recovery unit 80 identifies the faulty job on the basis of the route interdependence data (step S302).

The API fault identification and recovery unit 80 then determines whether interdependence is confirmed between the faulty job identified in step S302 and the job interdependent with the faulty job (step S303).

In a case where the interdependence is confirmed in step S303, the API fault identification and recovery unit 80 recovers from the fault by retrying the faulty job and by changing jobs based on the route interdependence data (step S304).

In a case where the interdependence is not confirmed in step S303, the API fault identification and recovery unit 80 recovers from the fault by retrying the job interdependent with the fault and by changing jobs based on the route interdependence data (step S305).

The API fault identification and recovery unit 80 then recovers from the fault by retrying and changing the faulty job (step S306).

If it is determined in step S200 that a rollback is present (step S401), the API fault identification and recovery unit 80 identifies the faulty job on the basis of the route interdependence data (step S402).

The API fault identification and recovery unit 80 then stops execution of the faulty job thus identified (step S403).

The API fault identification and recovery unit 80 then determines whether interdependence is confirmed between the identified faulty job and the job interdependent with the faulty job (step S404).

In a case where the interdependence is confirmed in step S404, the API fault identification and recovery unit 80 recovers from the fault by retrying an automatic rollback from an automatic recovery checkpoint of the faulty job (step S405).

In a case where the interdependence is not confirmed in step S404, the API fault identification and recovery unit 80 recovers 1 from the fault by retrying a rollback on the job interdependent with the fault (step S406).

The API fault identification and recovery unit 80 then recovers from the fault by retrying an automatic rollback on the faulty job (step S407).

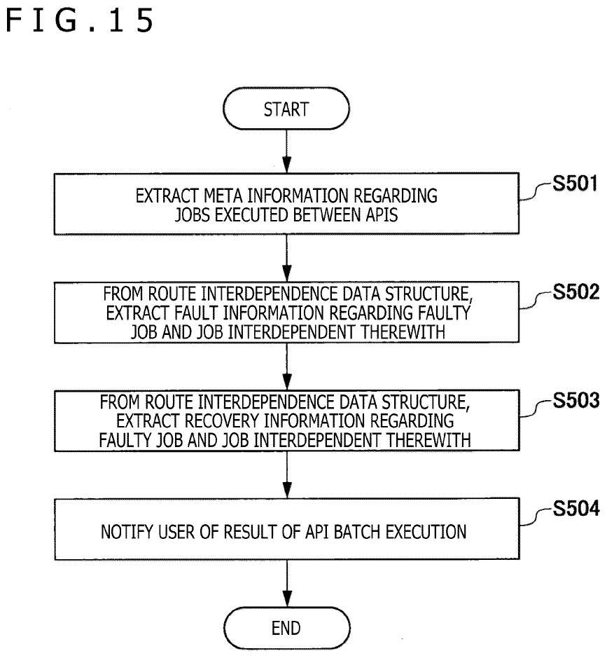

FIG. 15 is a flowchart of exemplary processing performed by the user notification unit 90 (see FIG. 9) in the fault detection and recovery system 40.

The user notification unit 90 extracts meta information regarding the jobs executed between APIs (step S501).

Next, from the route interdependence data structure, the user notification unit 90 extracts fault information regarding the faulty job and the job interdependent with the faulty job (step S502).

The user notification unit 90 further extracts, from the route interdependence data structure, recovery information regarding the faulty job and the job interdependent with the faulty job (step S503).

The user notification unit 90 then notifies the users (data center business operators) of the result of API batch execution (step S504). The terminals at the business operators 10a, 10b, and 10c display the results conveyed in step S504.

### [Notification Screen Given by User Notification Unit]

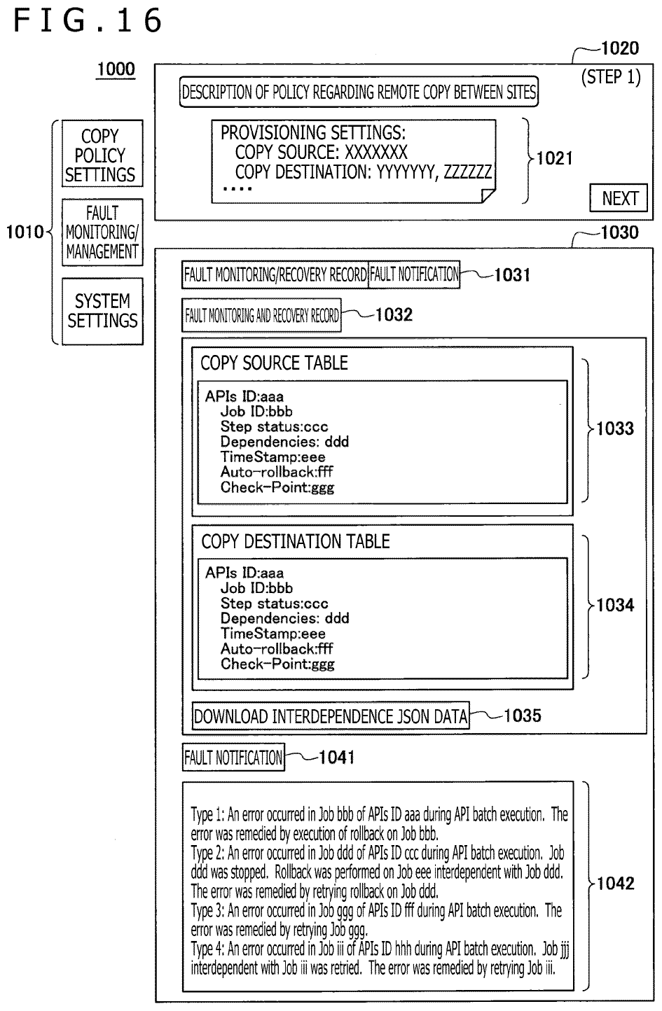

FIG. 16 depicts an exemplary notification screen 1000 displayed on the terminals at the business operators 10a, 10b, and 10c following notification by the user notification unit 90.

The notification screen 1000 in FIG. 16 includes display item setting buttons 1010 on the left part of the screen. The display item setting buttons 1010 include a copy policy setting button, a fault monitoring/management button, and a system setting button.

The notification screen 1000 has a user setting region 1020 and a fault notification region 1030 as specific display items.

The user setting region 1020 corresponds to the user request transmitted in step S1 in the flowchart of FIG. 10. The user setting region 1020 displays a description of the policy on remote copy between sites.

Specifically, the user setting region 1020 has, for example, provisioning settings 1021 such as a data copy source address and a copy destination address input from the terminal and displayed. The settings are transmitted to the storage management system 20 by a user request (in step S1 of FIG. 10).

The fault notification region 1030, which is a region where notification is made by the user notification unit 90, displays a title 1031 of fault monitoring/recovery record and fault notification. In the fault notification region 1030, a fault monitoring and recovery record field 1032 displays a detailed description of a copy source table 1033 and a copy destination table 1034.

The fault monitoring and recovery record field 1032 also displays an interdependence JavaScript Object Notation (JSON) data download button 1035. On the terminal displaying this screen, the download button 1035 may be selectively operated to download and display interdependence JSON data. Incidentally, JSON is a format for use by APIs for processing text data.

A fault notification field 1041 displays detailed information 1042 regarding a fault.

Specifically, the detailed information 1042 indicates in what circumstances each error occurred as a fault and how the errors were remedied.

As discussed above, the present embodiment is configured to have more than one set of storage set up at multiple sites and managed by high-level and low-level APIs, and a fault occurring in any set of storage is easily detected and remedied. That is, a low-level API fault occurring halfway through execution of the high-level API is identified by the high-level API that in turn notifies the user (business operator) of the fault. Further, low-level API faults can be remedied under control of the high-level API.

### [Variations]

The embodiment discussed above is intended to explain the present invention in a detailed, easy-to-understand manner and not necessarily representative of all the explained configurations.

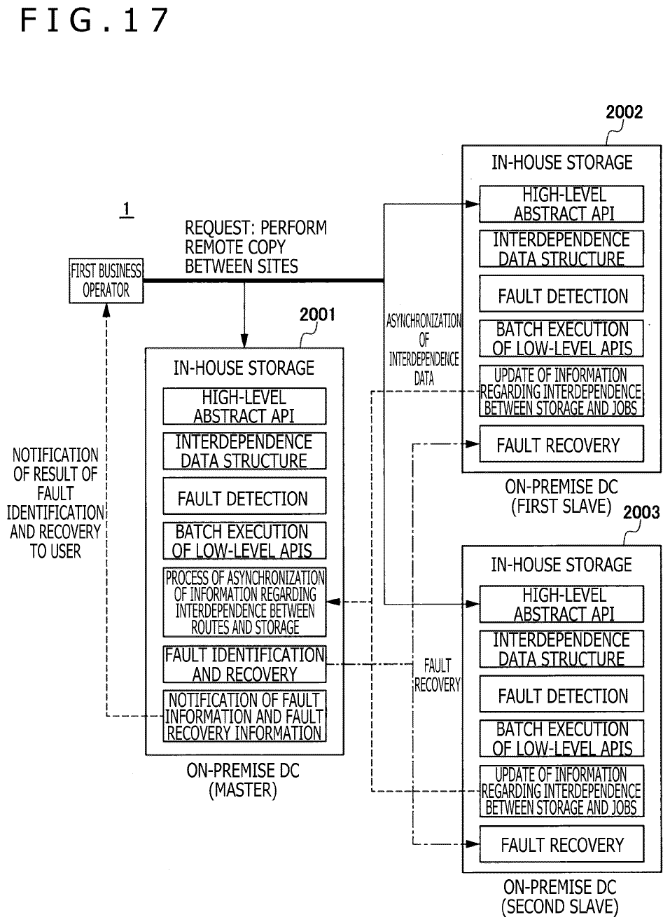

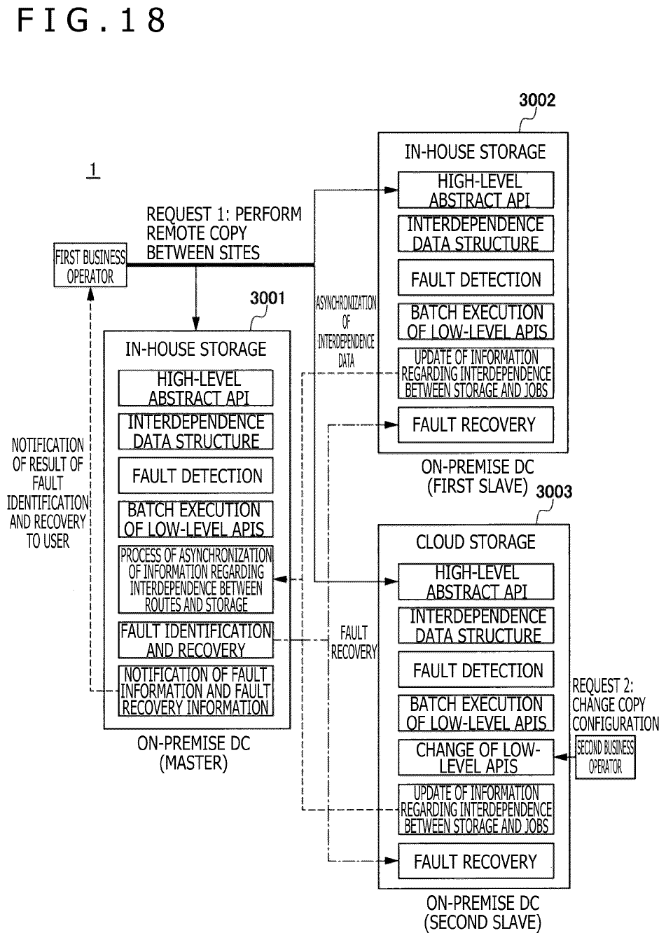

For example, whereas each set of storage in the system 1 in FIG. 1 is assumed to be cloud storage, the invention can also be applied to a case where more than one set of storage are set up at multiple sites or a case where only some of more than one set of storage are configured as cloud storage. Examples of these cases are indicated in FIGS. 17 and 18.

An example in FIG. 17 is a configuration in which an on-premise data center 2001 as the master, an on-premise data center 2002 as a first slave, and an on-premise data center 2003 as a second slave are set up at different sites.

The configuration in FIG. 17 is a storage configuration involving multiple sites without using cloud storage. In the example of FIG. 17, each of the sites has a high-level API (high-level abstract API) and low-level APIs. In that sense, the example in FIG. 17 may be said to be configured substantially the same as the system 1 in FIG. 1.

The data centers 2001, 2002, and 2003 each have the high-level abstract API and low-level APIs. For example, a remote copy between the sites is performed by a request from the first business operator.

Here, the data centers 2001, 2002, and 2003 are each configured to have the fault detection and recovery system 40 acquiring the interdependence data structure, for example, to identify and recover from the fault as explained above with reference to FIG. 1 and other drawings.

For example, the data center 2001 as the master acquires beforehand the information regarding the interdependence between storage and jobs from the data centers 2002 and 2003 as the slaves through the process of asynchronization of information regarding interdependence between routes and storage. The storage-job interdependence information should preferably be acquired periodically.

Upon occurrence of a fault at the data center 2002 or 2003, the data center 2001 identifies the fault on the basis of the acquired interdependence information, for example, and performs a recovery process. Further, the data center 2001 notifies the user (first business operator) of the result of the fault identification and recovery.

An example in FIG. 18 is a configuration having an on-premise data center 3001 as the master, an on-premise data center 3002 as the first slave, and an on-premise data center 3003 as the second slave. In the case of the example in FIG. 18, only the on-premise data center 3003 as the second slave is cloud storage.

The case of the example in FIG. 18 is also a configuration in which the data centers 3001, 3002, and 3003 each have the high-level abstract API and low-level APIs. For example, a remote copy between the sites is carried out by a request from the first business operator.

Here, the data centers 3001, 3002, and 3003 are each configured to have the fault detection and recovery system 40 acquiring the interdependence data structure, for example, to identify and recover from the fault as explained above with reference to FIG. 1 and other drawings.

Specifically, in the case of the example in FIG. 18, the data center 3001 as the master also acquires beforehand the information regarding the interdependence between storage and jobs from the data centers 3002 and 3003 as the slaves through the process of asynchronization of information regarding interdependence between routes and storage. The storage-job interdependence information should preferably be acquired periodically.

Upon occurrence of a fault at the data center 3002 or 3003, the data center 3001 identifies the fault on the basis of the acquired interdependence information, for example, and performs a recovery process accordingly.

Here, the data center 3003, which is cloud storage, is set up for use by other business operators as well. This raises a possibility that a copy configuration change request (request 2 in FIG. 18) may be issued from the second business operator, as depicted in FIG. 18. If low-level APIs of the data center 3003 are changed as a result of the request 2, the information regarding the interdependence between storage and jobs is updated.

As a result, the data center 3003 as the master can identify the fault that has occurred, on the basis of the acquired interdependence information, and can recover from the identified fault accordingly.

As explained above, the present invention can also be applied to the configuration having multiple storage sites, none of which is cloud storage, as well as to the configuration where in-house storage is combined with cloud storage.

In the configuration of FIG. 1, the fault detection and recovery system 40 detects a fault and recovers from the detected fault. Alternatively, the fault detection and recovery system 40 may detect a fault, notify the user such as a business operator of the detected fault, and let another system recover from the fault on the basis of the information regarding the fault.

In the configuration diagrams in FIG. 1 and other drawings, control lines and information lines considered necessary only for the purpose of explanation are indicated. Control lines and information lines required for product implementation may not all be included. In practice, almost all configurations may be considered to be connected with one another.

The flowcharts in FIG. 10 and other drawings are only examples. Some of the steps in these flowcharts may be changed in sequence or may be carried out simultaneously as long as the results of the processing are substantially the same.

The fault detection and recovery system 40 explained above in conjunction with the embodiment may be implemented by a program executing the steps in the flowchart of FIG. 10. This program may be prepared in the storage unit 42 in FIG. 1, for example. As another alternative, the program performed by a computer acting as the fault detection and recovery system 40 may reside on such a recording medium as an external memory, an integrated circuit (IC) card, a secure digital (SD) card, or an optical disk. The program may then be transferred from the recording medium to the computer configured to function as the fault detection and recovery system 40.

What is claimed is:

1. A storage management system for managing more than one set of storage set up at multiple sites, by using a low-level storage management interface provided for each set of storage, the storage management system further having a high-level storage management interface integrally controlling the low-level storage management interfaces, the storage management system comprising:
a storage management interface interdependence data generation unit configured to generate interdependence data describing information regarding interdependence between the storage management interfaces upon calling of any low-level storage management interface depending on use status of the low-level storage management interfaces;
a job interdependence data generation unit configured to generate interdependence meta data upon successful execution of a job by the high-level storage management interface; and
a fault identification unit configured to identify a fault of the low-level storage management interface upon failure of the high-level storage management interface to execute a job, the identification being performed by use of an interdependence data structure generated by the storage management interface interdependence data generation unit and the interdependence meta data generated by the job interdependence data generation unit.

2. The storage management system according to claim 1, wherein
the fault identification unit identifies the faulty job by acquiring the interdependence data on the job currently being executed from the storage management interface interdependence data generation unit.

3. The storage management system according to claim 2, wherein
the interdependence data generated by the storage management interface interdependence data generation unit includes automatic rollback presence/absence data, and,
in a case where the job execution by the high-level storage management interface has failed and where the automatic rollback is absent, the identification fault unit acquires the interdependence data on the job currently being executed from the data generated by the storage management interface interdependence data generation unit, before notifying the high-level storage management interface of the interdependence between jobs of the low-level storage management interfaces along with error-related information.

4. The storage management system according to claim 3, wherein
the fault identification unit further has a fault recovery function, and
the fault identification unit retries the faulty job from an automatic recovery checkpoint.

5. The storage management system according to claim 3, wherein,
in the case where the automatic rollback is present, the fault identification unit periodically notifies the high-level storage management interface of the interdependence between jobs of the low-level storage management interfaces along with execution status information regarding each task.

6. The storage management system according to claim 3, wherein
the fault identification unit further has a fault recovery function, and
the fault identification unit recovers from the fault by retrying a job interdependent with the faulty job.

7. A storage management method for managing more than one set of storage set up at multiple sites, by using a low-level storage management interface provided for each set of storage, the storage management method further having a high-level storage management interface integrally controlling the low-level storage management interfaces, the storage management method comprising:
a storage management interface interdependence data generation process that generates interdependence data describing information regarding interdependence between the storage management interfaces upon calling of any low-level storage management interface depending on use status of the low-level storage management interfaces;
a job interdependence data generation process that generates interdependence meta data upon successful execution of a job by the high-level storage management interface; and
a fault identification process that identifies a fault of the low-level storage management interface upon failure of the high-level storage management interface to execute a job, the identification being performed by use of an interdependence data structure generated by the storage management interface interdependence data generation process and the interdependence meta data generated by the job interdependence data generation process.
